(19) United States
(12) Patent Application Publication
(10) Pub. No.: US 2025/0326152 A1
(43) Pub. Date: Oct. 23, 2025

(54) PERFORATION FORMING MACHINE, SHEET PROCESSING APPARATUS, AND IMAGE FORMING SYSTEM

(71) Applicant: Konica Minolta, Inc., Tokyo (JP)

(72) Inventor: Motoyuki FUJIEDA, Tokyo (JP)

(21) Appl. No.: 19/187,065

(22) Filed: Apr. 23, 2025

(30) Foreign Application Priority Data
Apr. 23, 2024 (JP) 2024-069651

(51) Int. Cl. B26F 1/18; B26D 3/08; G03G 15/00

(52) U.S. Cl. CPC B26F 1/18; B26D 3/085; G03G 15/6582; G03G 2215/00814

(57) ABSTRACT

A perforation forming machine including, a biasing mechanism that constantly biases a cutter toward a receiving base; and a cam configured to form a state in which the cutter can be pressed against the receiving base by a biasing force and a state in which the cutter is separated from the receiving base against the biasing force. A presser is disposed in a state in which the perforating blade is separated from the receiving base via the sheet and the presser is configured so as to be able to press the cutter toward the receiving base. In a case in which the perforating blade is separated from the receiving base via the sheet, the cam is made to abut against the presser to displace the cutter toward the receiving base, and the perforating blade is pressed down to a height at which the perforating blade penetrates the sheet.

### CROSS REFERENCE TO RELATED APPLICATIONS

The present invention claims priority under 35 U.S.C. § 119 to Japanese Application No. 2024-069651, filed on Apr. 23, 2024, the entire contents of which being incorporated herein by reference.

### BACKGROUND OF THE INVENTION

### Technical Field

The present invention relates to a perforation forming machine, a sheet processing apparatus, and an image forming system.

### Description of Related Art

Post-processing such as cutting is performed on a sheet on which an image is formed by the image forming apparatus. Providing perforations in addition to the cutting processing increases the variety of uses of the product, thus increasing the added value.

Conventionally, a sheet processing apparatus (sheet material processing machine) that can form a perforation at a necessary place of a sheet material is known (see Japanese Patent No. 6111401). The mechanism for providing the perforation rotatably supports a cutter having a perforating blade on a support member. The perforating blade of the cutter is constantly biased against a receiving base with a predetermined pressing force. A groove into which the perforating blade can be inserted is formed in the receiving base. Therefore, by conveying the sheet between the perforating blade and the receiving base, the perforating blade is made to penetrate the sheet, and by moving the perforating blade or the sheet in a processing direction, a perforation is provided.

Incidentally, in order to form a perforation, it is necessary to press the perforating blade against the sheet and cause the perforating blade to penetrate the sheet, but when the perforating blade is pressed against the sheet, there are cases in which contact is made from a belly of the blade edge. For example, in a case in which the perforating blade is pressed against the sheet in order to form the perforation from the middle of the sheet, the blade edge is likely to abut against the sheet from its belly portion. In addition, in a guillotine-type cutter, the belly portion of the blade edge of the perforating blade abuts on the sheet.

A higher pressing force is required in a case in which the blade edge abuts on the sheet from its belly portion as compared with a case in which the blade edge abuts on the sheet from its corner portion. Therefore, in a case in which the surface hardness of the sheet increases, the perforating blade cannot penetrate the sheet in a case in which the perforating blade abuts on the sheet from the belly portion of a blade edge, and thus a disadvantage in which the perforation is not formed occurs.

In order to cope with such a disadvantage, it is possible to adopt a method of increasing biasing force for pressing the perforating blade and making the blade edge of the perforating blade sharper to improve the cutting quality. However, when these methods are adopted, there is a disadvantage that durability of the perforating blade decreases.

### SUMMARY OF THE INVENTION

The present invention has been made in consideration of such circumstances, and an object thereof is to provide a perforation forming machine capable of forming perforations in a sheet regardless of a type of sheet while avoiding a reduction in durability of a perforating blade, a sheet processing apparatus equipped with the perforation forming machine, and an image forming system including the sheet processing apparatus.

In order to achieve the above object, a perforation forming machine according to the present invention is a perforation forming machine that includes a processing machine capable of forming a perforation on a sheet conveyed between a cutter including a perforating blade, and a receiving base that receives the cutter, the perforation forming machine including:
a biasing mechanism that constantly biases the cutter toward the receiving base; and
a cam configured to form a state in which the cutter can be pressed against the receiving base by a biasing force of the biasing mechanism and a state in which the cutter is separated from the receiving base against the biasing force of the biasing mechanism,
wherein a presser that is disposed within a moving route of the cam in a state in which the perforating blade is separated from the receiving base via the sheet and the presser is configured so as to be able to press the cutter toward the receiving base, and
wherein, in a case in which the perforating blade is separated from the receiving base via the sheet, the cam is made to abut against the presser to displace the cutter toward the receiving base, and the perforating blade is pressed down to a height at which the perforating blade penetrates the sheet.

According to another aspect, a sheet processing apparatus includes the above-described perforation forming machine which is detachably attached to the sheet processing apparatus as one of functional units.

According to another aspect, an image forming system includes an image forming apparatus that forms an image on a sheet, and the above-described sheet processing apparatus that forms the perforation on the sheet on which the image has been formed by the image forming apparatus.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 shows a schematic configuration of an image forming system according to the present embodiment;

FIG. 2 is a functional block diagram showing a control structure of the image forming system according to the present embodiment;

FIG. 3 is a diagram illustrating a schematic configuration of a perforation forming unit (FD perforation) according to the present embodiment, and is a cross-sectional view cut so that a cutter and a lower receiving base can be seen when viewed from an upstream side in a conveyance direction of a sheet;

FIG. 4 is a perspective view of a schematic configuration of the inside of the perforation forming unit according to the present embodiment when viewed from the upstream side in the conveyance direction of the sheet;

FIG. 5 is a perspective view of a schematic configuration of a lower guide member installed in the perforation forming unit illustrated in FIG. 4 as viewed from the upstream side in the conveyance direction of the sheet;

FIG. 6 is a perspective view illustrating a processing machine that forms a perforation according to the present embodiment;

FIG. 7 is a partially cutout cross-sectional view of the processing machine for forming the perforation according to the present embodiment when viewed from the front;

FIG. 8 is a perspective view of the processing machine for forming the perforation according to the present embodiment, in which an upper guide member and a lower guide member are partially cut out so that an internal structure can be seen;

FIG. 9 is a side sectional view taken along line A-A of FIG. 7 in the processing machine for forming the perforation according to the present embodiment;

FIG. 10 is a perspective view of the processing machine for forming a perforation according to the present embodiment in which an upper guide member, a lower guide member, and a cutter holding member are partially cut out so that an internal structure can be seen, and is a diagram illustrating a case of inserting a sheet into a conveyance path in order to form the perforation in the conveyance direction of the sheet;

FIG. 11A is a front view (a view as viewed from the conveyance direction of the sheet) illustrating a state in which a rotary type cutter used in the present embodiment is installed in a cutter installation member fixed to a rotation shaft;

FIG. 11B is a side view of FIG. 11A as viewed from the right side;

FIG. 11C is a side view of FIG. 11A as viewed from the left side;

FIG. 12A is a side view for explaining a relationship between the cutter and the lower receiving base;

FIG. 12B is a cross-sectional view illustrating a relationship between the perforation of the cutter and a groove portion of the lower receiving base;

FIG. 13A is a view for explaining the movement of the cutter holding member of the processing machine according to the present embodiment, and is a side view showing a state in which the perforation of the blade penetrates the sheet;

FIG. 13B is a diagram for explaining the movement of the cutter holding member of the processing machine according to the present embodiment, and is a side view showing a state in which the perforation of the cutter stays on a surface of the sheet;

FIG. 14A is a diagram illustrating a state in which the cutter is separated from the lower receiving base in a case in which the perforation is formed on the sheet having low surface hardness;

FIG. 14B is a diagram illustrating a state in which the cutter is biased toward the lower receiving base only by biasing force of a biasing member (compression spring) in a case in which the perforation is formed on the sheet having low surface hardness;

FIG. 15A is a diagram illustrating a state in which the cutter is separated from the lower receiving base in a case where the perforation is formed on the sheet having high surface hardness;

FIG. 15B is a diagram illustrating a state in which the cutter is biased toward the lower receiving base only by the biasing force of the biasing member (compression spring) in a case in which the perforation is formed on the sheet having high surface hardness;

FIG. 15C is a diagram illustrating a state in which a pressing portion (follow-up striking guide piece) is pressed by a cam in a case in which the perforation is formed on the sheet having high surface hardness;

FIG. 16 is a perspective view illustrating an example in which the cam and the pressing portion (follow-up striking guide piece) that forcibly presses the cutter are provided in the processing machine that forms the perforation in a direction orthogonal to the conveyance direction of the sheet;

FIG. 17A is a diagram illustrating a schematic configuration in a case where the cutter is a guillotine type; and

FIG. 17B is a diagram illustrating a schematic configuration of the processing machine in a case where the cutter is the guillotine type.

### DETAILED DESCRIPTION

Hereinafter, one or more embodiments of the present invention will be described with reference to the drawings. However, the scope of the invention is not limited to the disclosed embodiments.

Hereinafter, embodiments of the present invention will be described in detail with reference to the drawings.

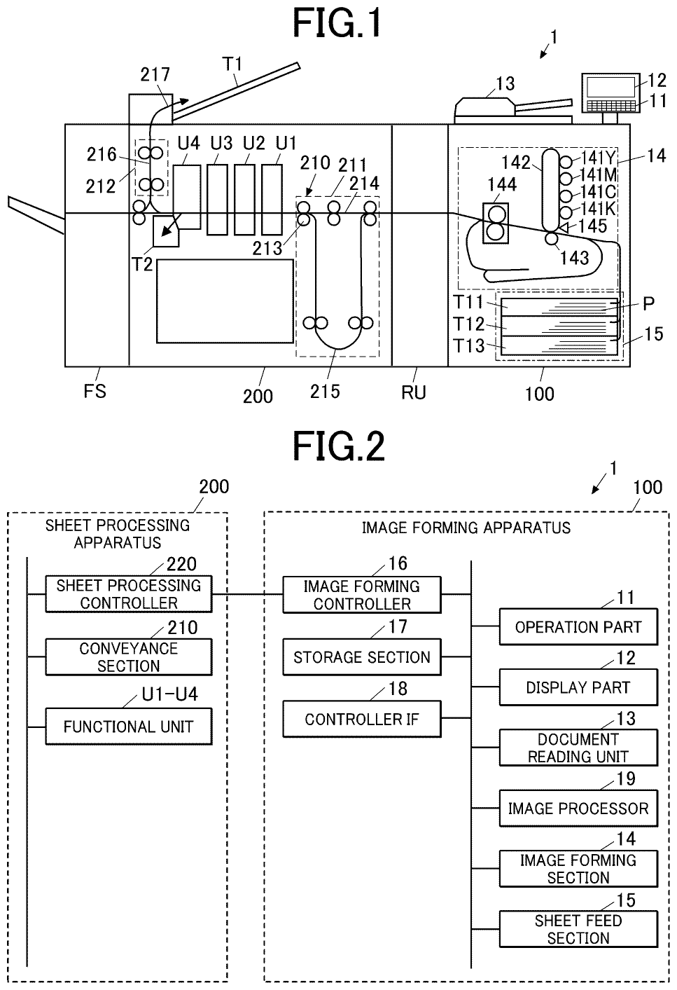

As shown in FIG. 1 and FIG. 2, the image forming system 1 according to the present embodiment includes an image forming apparatus 100, a relay unit RU, a sheet processing apparatus 200, and a finisher FS.

The image forming apparatus 100 forms a color image by an electrophotographic method on the basis of image data obtained by reading an image from a document or image data received from an external device. The image forming apparatus 100 includes an operation part 11 and a display part 12, a document reading unit 13, an image forming section 14, a sheet feed section 15, an image forming controller 16, a storage section 17, a controller interface (IF) 18, and an image processing section 19.

The operation part 11 includes a touch screen formed to cover a display screen of the display part 12, and various operation buttons such as numeric buttons and a start button. The operation part 11 outputs an operation signal based on a user's operation to the image forming controller 16.

The display part 12 includes a liquid crystal display (LCD) and displays various screens in accordance with an instruction of a display signal input from the image forming controller 16.

The document reading unit 13 includes an automatic document feeder (ADF, sheet feed device), a scanner, and the like, and outputs image data obtained by reading the image of the document to the image forming controller 16.

The image forming section 14 forms the image on a sheet supplied from the sheet feed section 15 on the basis of the image data subjected to image processing. The image forming section is configured to include photosensitive drums 141Y, 141M, 141C, and 141K corresponding to colors of yellow (Y), magenta (M), cyan (C), and black (K), an intermediate transfer belt 142, a secondary transfer roller 143, a fixing section 144, a density sensor 145, and the like.

The photosensitive drum 141Y is uniformly charged and is then scanned and exposed by a laser beam based on the image data for a yellow color, so that an electrostatic latent image is formed. Next, the yellow color is applied to the electrostatic latent image on the photosensitive drum, and development is performed. For the other photosensitive drums 141M, 141C, and 141K, the same processing as that for the photosensitive drum 141Y is performed, except that the colors to be handled are different.

The toner images in the respective colors formed on the photosensitive drums 141Y, 141M, 141C, and 141K are sequentially transferred onto a rotating intermediate transfer belt 142 (primary transfer). That is, a color toner image in which the toner images of four colors are superimposed is formed on the intermediate transfer belt 142. The color toner images on the intermediate transfer belt 142 are collectively transferred onto the sheet by the secondary transfer roller 143 (secondary transfer).

The fixing section 144 includes a heating roller that heats the sheet onto which the color toner image has been transferred and a pressure roller that pressurizes the sheet and fixes the color toner image onto the sheet by heating and pressurizing.

The sheet feed section 15 includes sheet feed trays T11 to T13 and supplies the sheet to the image forming section 14. Each of the sheet feed trays T11 to T13 stores sheets of a sheet type and a size determined in advance for each sheet feed tray.

The image forming controller 16 includes a CPU, a ROM, and a memory.

The CPU reads out various processing programs stored in the ROM and controls the operation of each unit of the image forming apparatus 100 according to the programs. Furthermore, when performing post-processing on the output sheet, the CPU instructs the sheet processing apparatus 200 to perform predetermined post-processing.

The sheet processing apparatus 200 is an apparatus that performs post-processing on the sheet output from the relay unit RU as necessary. Examples of the post-processing include slitter processing, dobby slitter processing, CD cutting processing, creasing processing, and FD/CD perforation processing. These kinds of post-processing are not essential, and the post-processing is executed only when instructed by the image forming apparatus 100. When there is no post-processing, the sheet processing apparatus 200 conveys the conveyed sheet to the finisher FS as it is.

The sheet processing apparatus 200 includes a sheet conveyance section 210, functional units U1 to U4, a purge tray T1 that ejects the sheet to be purged from the sheet processing apparatus 200, and a card tray T2 that ejects the sheet cut into a predetermined size by the sheet processing apparatus 200.

The sheet conveyance section 210 conveys the sheet conveyed from the relay unit RU to the functional units U1 to U4. Thereafter, the sheet subjected to the post-processing in the functional unit is conveyed to various trays (the purge tray T1 and the card tray T2) or the finisher FS.

The sheet conveyance section 210 includes a long sheet conveyance section 211 and a purge conveyance section 212. The sheet conveyance section 210 includes a plurality of conveyance roller pairs 213 and includes conveyance paths 214 to 217 as illustrated in FIG. 1. That is, the sheet conveyance section 210 includes a straight conveyance path 214 that corrects a skew of the sheet to be conveyed to the functional unit U1, and a bypass path 215 that bypasses the long sheet to be conveyed to the functional unit U1 to perform alignment in a CD-direction (sheet width direction). Furthermore, the sheet conveyance section 210 includes a reverse sheet ejection path 216 that reverses the sheet after the post-processing by the functional units U1 to U4 and ejects the sheet to the finisher FS, and a dual purpose path 217 that serves as both a sheet ejection path that ejects the sheet to the purge tray T1 and a reverse path that reverses the sheet.

The sheet conveyance section 210 conveys, by a plurality of conveyance roller pairs 213, a printing sheet conveyed from the image forming apparatus 100 to the post-processing section (functional units U1 to U4). Further, the sheet conveyance section 210 conveys the printing sheet subjected to the post-processing to the finisher FS. In the finisher FS, the sheet after the image formation is subjected to stapling, folding, punching, and the like.

The functional units U1 to U4 perform post-processing on the conveyed sheet.

The functional units U1 to U4 are manually selected and installed by a service person. For example, the most upstream functional unit U1 may be a top/bottom slitter, and the most downstream functional unit U4 may be a compact disk cutter (compact disk cutting unit) for compact disk cutting. In this case, the functional units U2 and U3 may be selected from a blead off slitter, a creaser (downward convex) or a creaser (upward convex), FD-perforation, CD-perforation, and the like.

The blead off slitter has a function of cutting, along the conveyance direction, a margin between products adjacent to each other in a direction orthogonal to the conveyance direction of the sheet. The creaser (downward convex) or the creaser (upward convex) has a function of performing crease processing on a sheet. The FD perforation or the CD perforation has a function of performing FD/CD perforation processing for forming a perforation in the sheet.

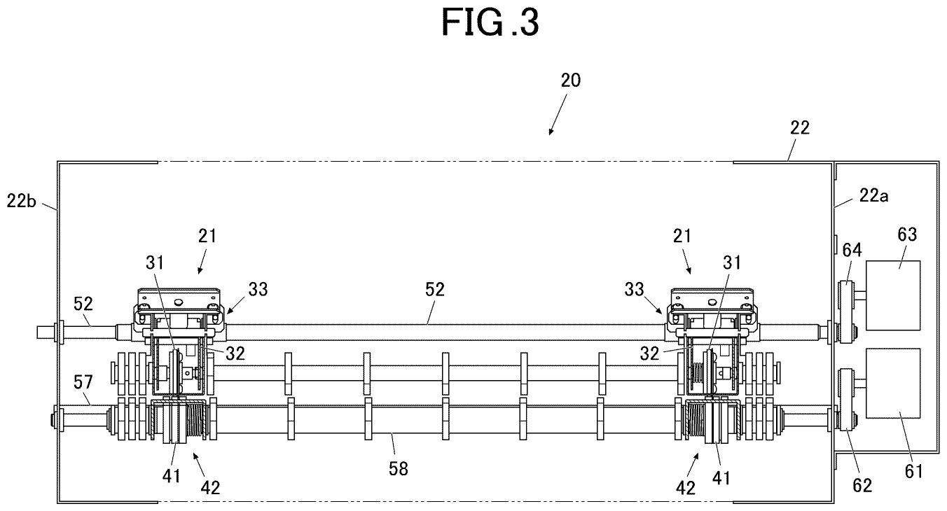

In the above-described functional units U1 to U4, modules selected in accordance with functions required by the user are detachably attached to unit housing receivers, and required functions are completed on a module-by-module basis. Of these units, the unit shown in FIG. 3 and subsequent figures is a perforation forming unit (corresponding to a perforation forming machine) 20 for forming the FD perforation on the conveyed sheet.

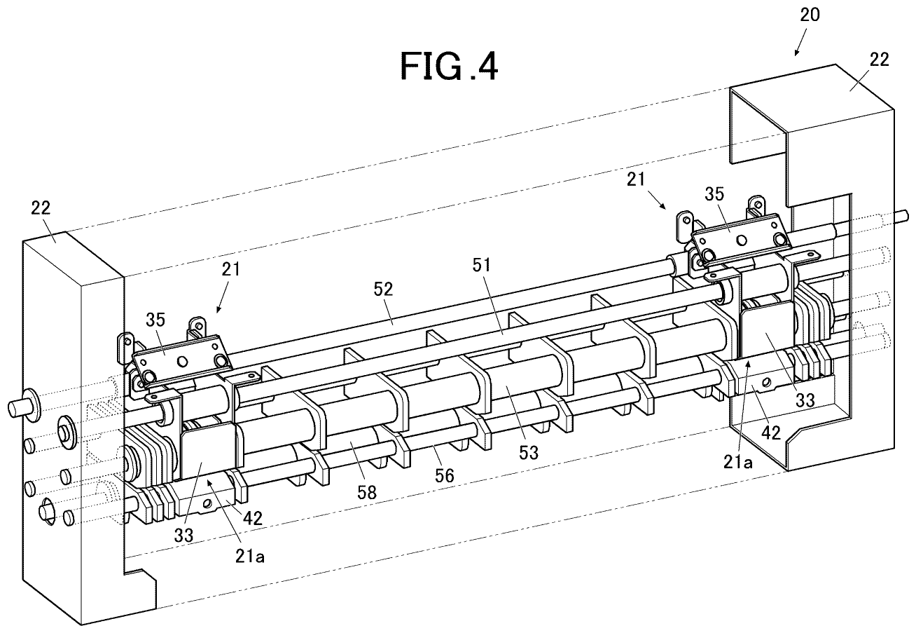

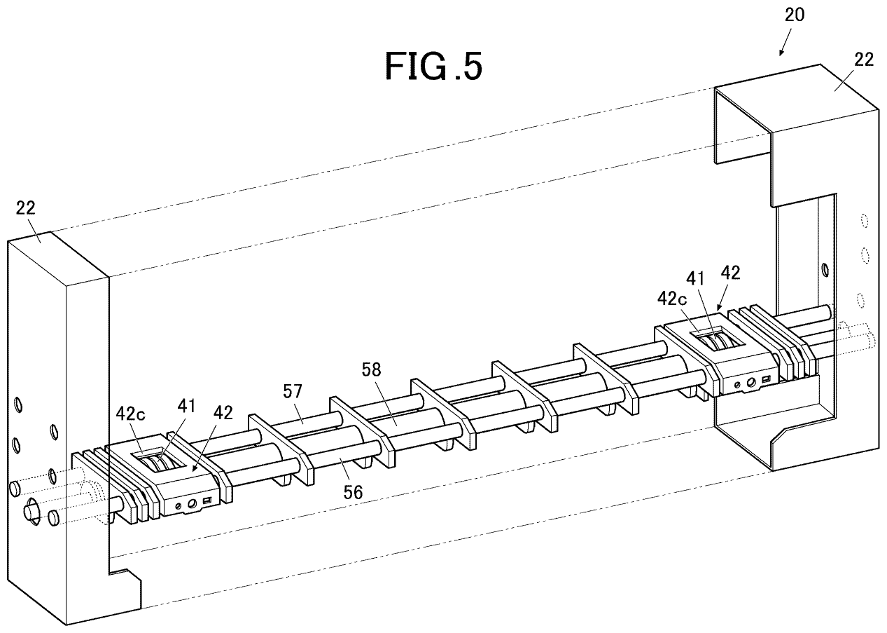

As shown in FIG. 3 to FIG. 5, the perforation forming unit 20 includes at least one processing machine 21 that forms the perforation on the sheet along the FD-direction (sheet conveyance direction) from a front end in the conveyance direction or from a middle of the sheet. In this example, a plurality of (for example, two) processing machines 21 are provided in the unit housing 22 at different positions in the direction orthogonal to the conveyance direction of the sheet conveyed by the sheet conveyance section 210.

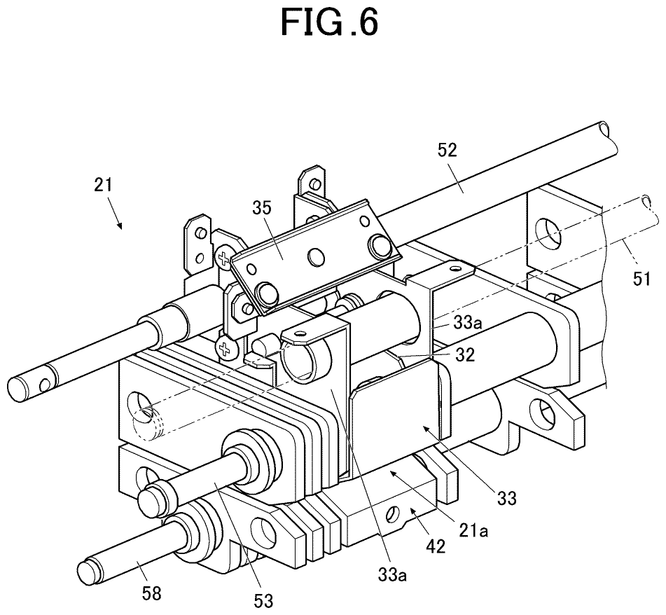

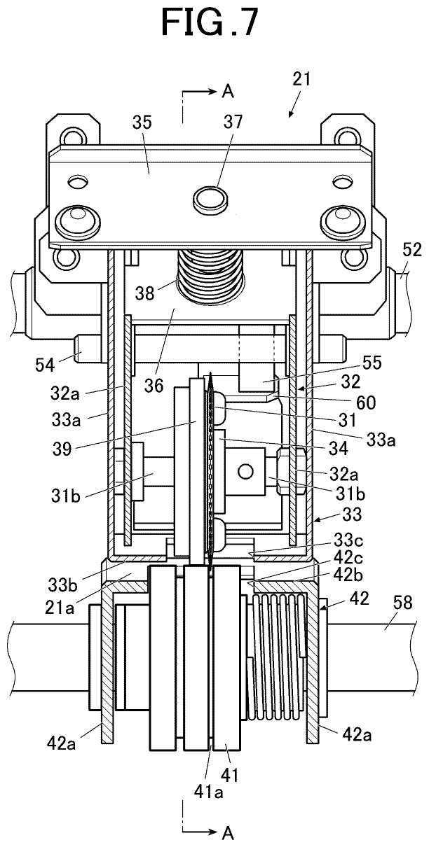

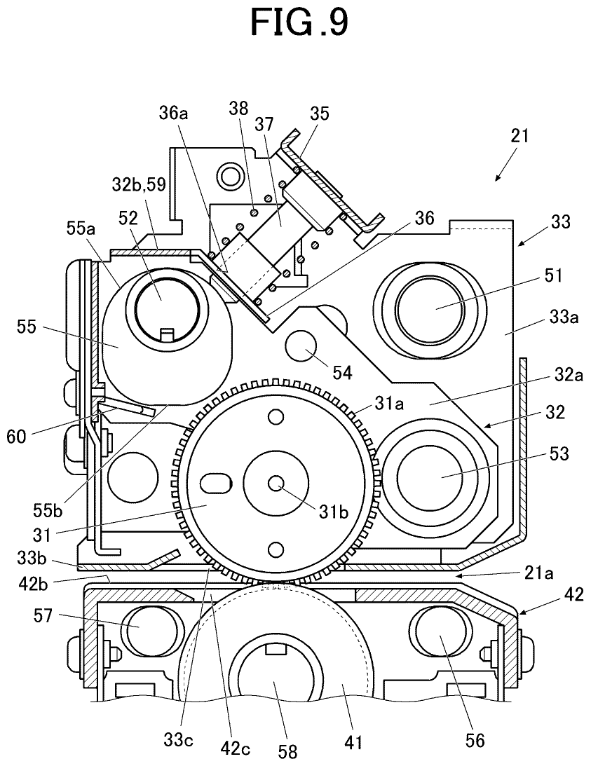

The processing machine 21 will be described with reference to FIG. 6 to FIG. 10 also. The processing machine 21 has an upper guide member 33 in which a cutter holding member 32 for rotatably holding a rotary type cutter 31 is incorporated, and a lower guide member 42 arranged below the upper guide member and provided with a rotary type lower receiving base 41 with which the cutter 31 is separably brought into contact.

The upper guide member 33 includes a pair of side walls 33a that oppose each other at a predetermined distance in a direction orthogonal to the conveyance direction and a connecting wall 33b that connects the pair of side walls 33a at lower end portions thereof. The upper guide member 33 has a shape in which at least an upper side and a downstream side are opened. Through the pair of side walls 33a of the upper guide member 33, a holding shaft 51 and a cam rotation shaft 52 (described later) which are bridged between housing walls 22a and 22b facing each other in the longitudinal direction of the unit housing 22 are inserted. The cam rotation shaft 52 is arranged on a downstream side of the holding shaft 51 in parallel therewith and is rotatably supported between the housing walls 22a and 22b. The upper guide member 33 is held at a predetermined height by the holding shaft 51 and the cam rotation shaft 52. An opening 33c for avoiding interference with the cutter 31 is formed in a lower wall (connecting wall 33b) of the upper guide member 33.

The lower guide member 42 includes a pair of side walls 42a that face each other at a predetermined distance in the direction orthogonal to the conveyance direction and a connecting wall 42b that connects the pair of side walls 42a at upper end portions thereof. The lower guide member 42 has a shape in which at least a lower side is opened. A pair of holding shafts 56 and 57 bridged between the housing walls 22a and 22b opposed to each other in the longitudinal direction of the unit housing 22 are inserted through the pair of side walls 42a of the lower guide member 42. The lower guide member 42 is held by these holding shafts 56 and 57 just below the upper guide member with a predetermined clearance.

The paired holding shafts 56 and 57 are arranged at the same height in the horizontal direction perpendicular to the conveyance direction, and a receiving base rotation shaft 58 is provided in parallel between the paired holding shafts 56 and 57. The receiving base rotation shaft 58 also penetrates through the pair of side walls 42a of the lower guide member 42. The rotary lower receiving base 41 is fixedly mounted on the receiving base rotation shaft 58 inside the lower guide member 42. An opening 42c for exposing the upper end portion of the lower receiving base 41 is formed on an upper surface (connecting wall 42b) of the lower guide member 42. The opening 33c of the upper guide member 33 and the opening 42c of the lower guide member 42 are formed at positions aligned with each other. The cutter 31 provided in the upper guide member 33 can be pressure-bonded to the lower receiving base 41 via the opening 33c formed on a lower surface of the upper guide member 33.

The cutter holding member 32 includes a pair of side walls 32a facing each other at a predetermined distance in the direction orthogonal to the conveyance direction, and a connecting wall 32b connecting the pair of side walls 32a at an upper part on the downstream side. The cutter holding member 32 has a shape opened at least at the lower part.

Between the housing walls 22a and 22b facing each other in the longitudinal direction of the unit housing 22, a holding member rotation shaft 53 is stretched between the holding shaft 51 and the holding shaft 56. The holding member rotation shaft 53 is inserted through the pair of side walls 33a of the upper guide member 33. The holding member rotation shaft 53 is also inserted through an upstream-side portion of the pair of side walls 32a of the cutter holding member 32, the upstream-side portion being positioned opposite to the connecting wall 32b. Therefore, the cutter holding member 32 is held so as to be rotatable about the holding member rotation shaft 53. The portion of the pair of side walls 32a of the cutter holding member 32 through which the cam rotation shaft 52 penetrates is formed as an arc-shaped hole 32c in order to avoid interference with the cam rotation shaft 52 in the range in which the cutter holding member 32 rotates.

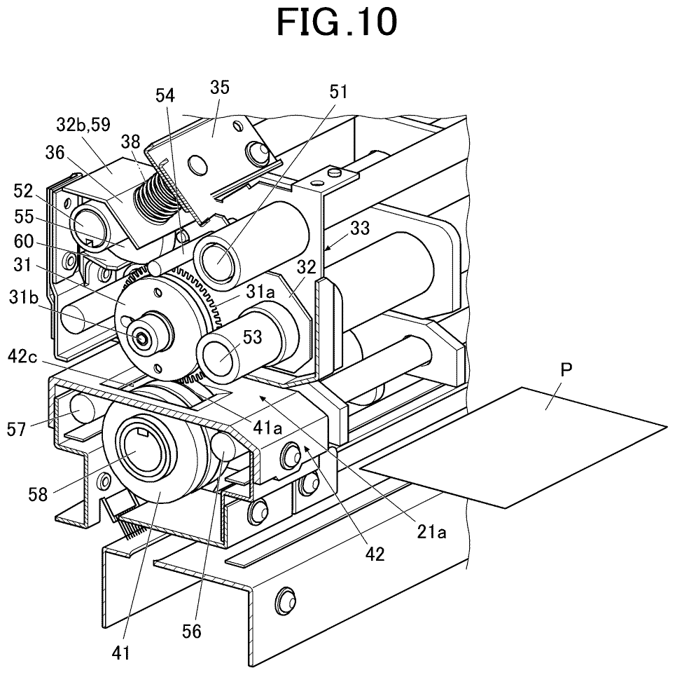

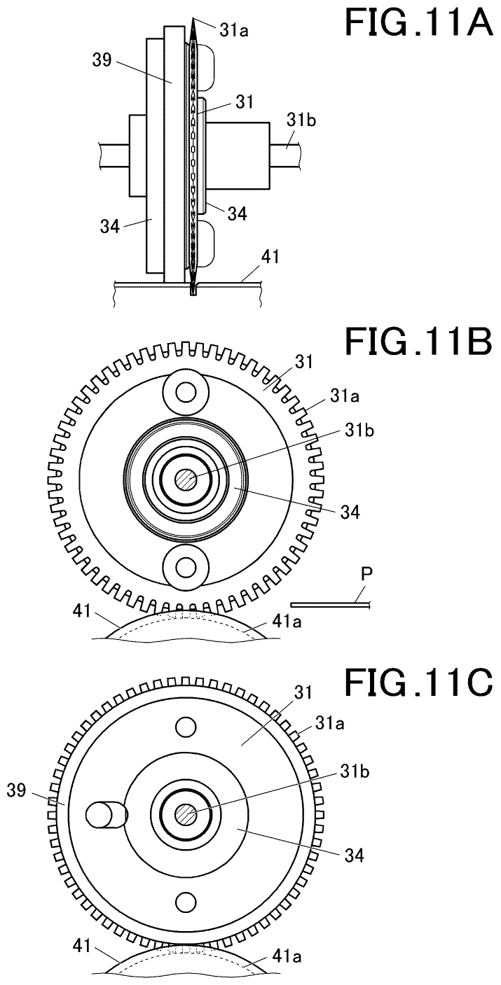

The cutter 31 is a roller for forming a mark of the perforation on the sheet, and as illustrated in FIGS. 11A, FIG. 11B, and FIG. 11C, a perforating blade 31a is continuously formed over the entire circumference along the circumferential direction on the outer circumferential surface. The cutter 31 is fixed by screwing to a cutter installation member 34 fixed to a rotation shaft 31b pivotally supported by the pair of side walls 32a of the cutter holding member 32. A rubber roller 39 is fixed to the outer periphery of the cutter installation member 34 adjacent to the cutter 31 so as to rotate together with the cutter 31. The rubber roller 39 is formed such that its outer diameter is slightly smaller than the outer diameter of the cutter 31 (the distance from the center of the cutter to the tip of the perforating blade). When the sheet is conveyed between the rubber roller 39 and the peripheral face of the lower receiving base 41 and the perforating blade 31a penetrates the sheet P, the rubber roller 39 abuts on the surface of the sheet P. Thus, the cutter 31 rotates with the movement of the sheet due to a friction force between the rubber roller 39 and the sheet P.

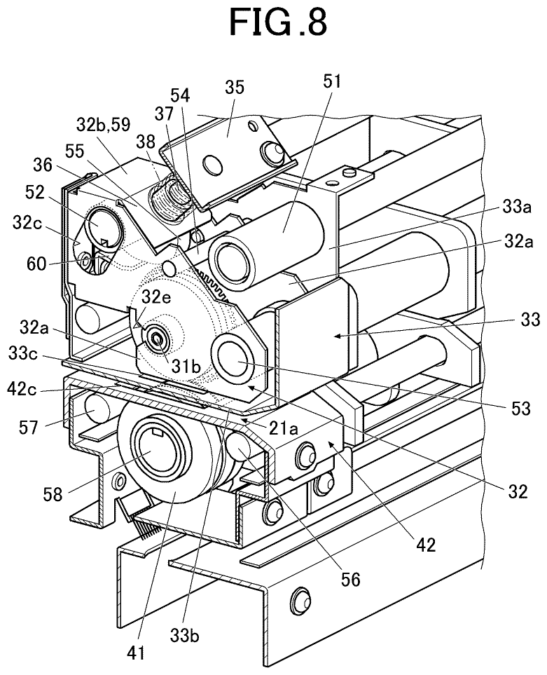

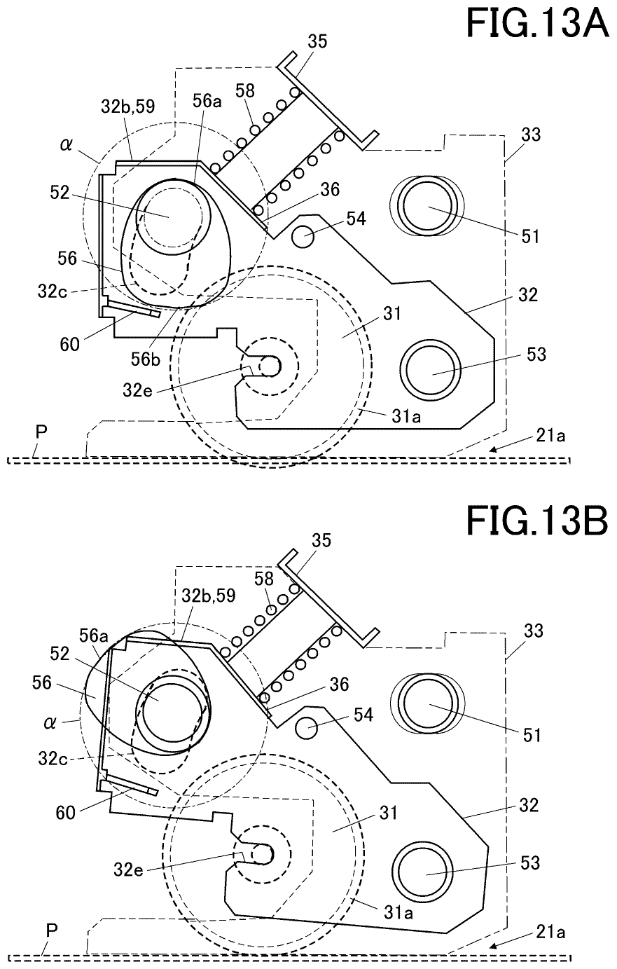

The rotation shaft 31b of the cutter 31 fixed via the cutter installation member 34 is rotatably supported by a holding groove 32e formed between the connecting wall 32b of the pair of side walls 32a of the cutter holding member 32 and the portion through which the holding member rotation shaft 53 is inserted (see FIG. 8 and FIG. 13).

Therefore, when the cutter holding member 32 is turned up and down around the holding member rotation shaft 53, the cutter 31 which is rotatably supported by the pair of side walls 32a of the cutter holding member 32 also moves up and down correspondingly.

The lower receiving base 41 is a roller for pressing the sheet P against the cutter 31 and is rotated by the rotation of the receiving base rotation shaft 58. The receiving base rotation shaft 58 is rotationally driven via the belt 62 by a first driving motor 61 formed of a stepper motor disposed on an outer side of the housing wall 22a of the unit housing 22.

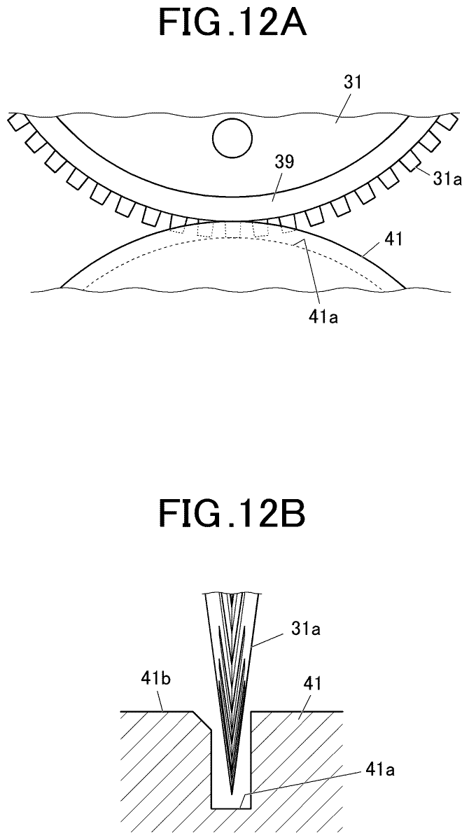

As illustrated in FIG. 12A and FIG. 12B, a groove portion 41a into which the perforating blade 31a of the cutter 31 is inserted is formed continuously over the entire circumference of the circumferential surface of the lower receiving base 41. The groove portion 41a is formed to have a depth such that a blade edge of the perforating blade 31a does not interfere with a bottom portion even in a state where the cutter 31 is pressed against the lower receiving base 41. Furthermore, on the outer peripheral surface (cylindrical surface) of the lower receiving base 41, a contact surface 41b against which the sheet is pressed by the rubber roller is provided adjacent to the groove portion 41a.

Note that reference numeral 54 denotes a spacer for maintaining the pair of side walls 32a of the cutter holding member 32 at a predetermined distance.

Incidentally, an upper end part of the upper guide member 33 is provided with a first spring receiver 35 bridged between the pair of side walls 33a. Further, a second spring receiver 36 is provided at the upper end portion of the cutter holding member 32 so as to extend between the pair of side walls 32a. These spring receivers 35 and 36 are provided in such a manner as to face each other, and a guide rod 37 which is provided in a protruding manner toward the second spring receiver 36 is attached to a surface of the first spring receiver 35 which faces the second spring receiver 36. The guide rod 37 is inserted through a through hole 36a provided in the second spring receiver 36 so as not to come off from the second spring receiver 36 within a rotating range of the cutter holding member 32. A compression spring (biasing member) 38 is elastically mounted around the guide rod 37 between the first spring receiver 35 and the second spring receiver 36. As a result, the cutter holding member 32 is always biased by a spring force of the compression spring (biasing member) 38 via the second spring receiver 36 in the counterclockwise direction in the drawing around the holding member rotation shaft 53. That is, the compression spring (biasing member) 38 always biases the cutter 31 in a direction in which the cutter 31 is pressed against the lower receiving base 41.

The spring force of the compression spring 38 is adjusted to such pressing force that, when a plain sheet having very general surface hardness is guided to the conveyance path 21a between the upper guide member 33 and the lower guide member 42, the belly portion of the blade edge of the perforating blade 31a penetrates through the sheet P even when the belly portion abuts against the surface of the sheet P.

Further, a plate-shaped cam 55 is externally mounted on the cam rotation shaft 52 at a portion located between the pair of side walls 32a of the cutter holding member 32. The cam 55 rotates integrally with the rotation of the cam rotation shaft 52. The cam rotation shaft 52 is rotationally driven via a belt 64 by a second drive motor 63, which is a stepper motor disposed outside the housing wall 22a of the unit housing 22.

The cam 55 is provided so as not to interfere with the guide rod 37. The cam 55 is formed such that the length (cam radius) from the center of the cam rotation shaft 52 to the cam surface is smallest in a predetermined section (first section 55a) in the circumferential direction. Furthermore, the cam is formed to have the largest cam radius in a predetermined second section 55b which is substantially 180° out of phase with the first section. Furthermore, the cam 55 is formed such that the cam radius continuously changes between the first section 55a and the second section 55b.

A portion of the cutter holding member 32 located above the cam rotation shaft 52 is provided with a separating guide piece 59 with which the cam 55 comes into contact from below when the second section of the cam 55 is directed upward relative to the cam rotation shaft 52, to displace the cutter holding member upward about the holding member rotation shaft 53. In this example, the separating guide piece 59 is replaced with the connecting wall 32b. Furthermore, a part of the cutter holding member 32 located below the cam rotation shaft 52 is provided with a follow-up striking guide piece (equivalent to a pressing portion, presser) 60 which is extended from the downstream end part of the cutter holding member 32 toward the upstream side.

In a case where the cutter 31 is in pressure contact with the lower receiving base 41 or in a case where the perforating blade 31a penetrates the sheet on the conveyance path 21a, as illustrated in FIG. 13A, the cam surface of the follow-up striking guide piece 60 is located at a position where the cam surface does not abut on the follow-up striking guide piece 60 even if the cam 55 is rotated. That is, the follow-up striking guide piece 60 is not arranged within a moving route a of the cam 55.

On the other hand, as illustrated in FIG. 13B, when the perforating blade 3a is separated from the lower receiving base 41 by a predetermined height or more via the sheet P (when the perforating blade 31a is separated from the lower receiving base 41 by the amount corresponding to the thickness of the sheet P), the cutter holding member 32 rotates upward around the holding member rotation shaft 53. Therefore, the follow-up striking guide piece 60 is also displaced upward. Since the position of the cam rotation shaft 52 does not change, the cam rotation shaft 52 relatively moves to the lower side of the hole 32c by an amount corresponding to the upward rotation of the cutter holding member 32. Therefore, the follow-up striking guide piece 60 is in a state of being arranged within the moving route a of the cam 55, and thus, when the cam 55 rotates in this state, the cutter 31 is pressed in a direction in which the cutter 31 comes into pressure contact with the lower receiving base 41. Therefore, even when the perforating blade 31a is stopped on the surface of the sheet P being conveyed in the conveyance path 21a, the perforating blade 31a of the cutter 31 penetrates the sheet P and is inserted into the groove portion 41a of the lower receiving base 41.

Note that the rotation of the cam 55 is controlled such that the second section 55b comes to a position facing the follow-up striking guide piece 60 at a timing at which a position at which a perforation is started to be formed on a sheet reaches the lowest end of the cutter or the vicinity thereof. In addition, when the formation of the perforation is completed, the rotation of the cam 55 is controlled such that the second section 55b of the cam 55 comes to a position where the second section 55b pushes up the separating guide piece 59.

In the above-described configuration, when the perforation forming unit 20 is attached to the sheet processing apparatus 200 and the sheet P is conveyed from the upstream side, the sheet P moves to the conveyance path 21a between the cutter 31 and the lower receiving base 41 (between the upper guide member 33 and the lower guide member 42).

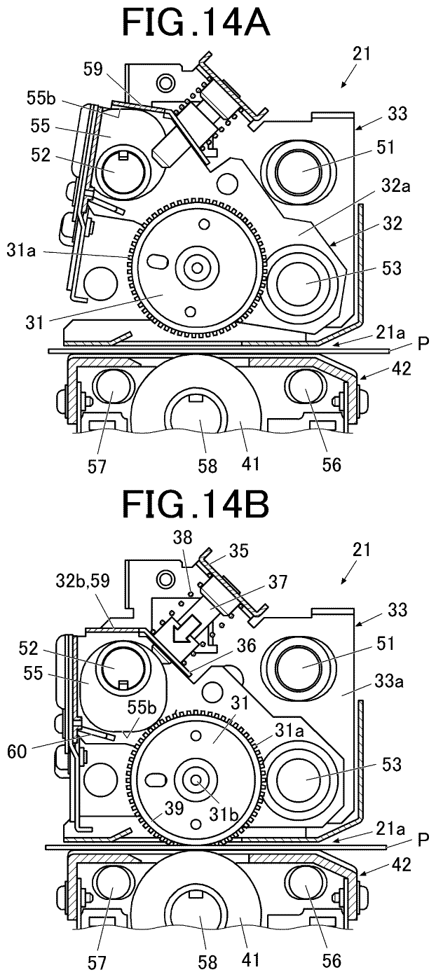

When a command to form the perforation is issued in accordance with the conveyance timing of the sheet, the cam 55 starts rotating by the second drive motor 63 from the state illustrated in FIG. 14A in which the second section 55b is in contact with the separating guide piece 59. When the second section 55b of the cam 55 is separated from the separating guide piece 59, the cutter holding member 32 is turned downward on the holding member rotation shaft 53 by the biasing force of the biasing member (compression spring 38), and the blade 31 moves toward the lower receiving base 41 along with this.

If the sheet is the plain sheet having a low surface hardness, the biasing force of the biasing member (compression spring 38) is set to a pressing force that causes the perforating blade 31a to penetrate the sheet P even when the belly portion of the blade edge of the perforating blade 31a comes into contact with the surface of the sheet, so that the perforating blade 31a penetrates the sheet P as shown in FIG. 14B. In this state, since the rubber roller 39 is in contact with the sheet P, the cutter 31 is also rotated by the frictional force between the sheet P and the rubber roller 39 as the sheet P is conveyed. Therefore, the subsequent perforating blades 31a sequentially penetrate the sheet P, and perforations are continuously formed in the sheet P. At this time, since the cutter holding member 32 is lowered until the cutter 31 causes the perforating blade 31a to penetrate the sheet P, the second section 55b of the cam 55 is not abutted against the follow-up striking guide piece 60 and is in a state of being opposed to the follow-up striking guide piece 60 with an interval.

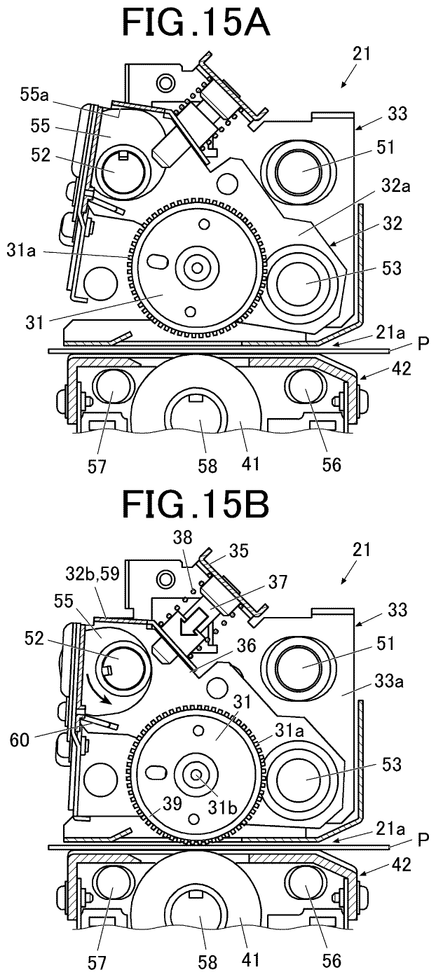

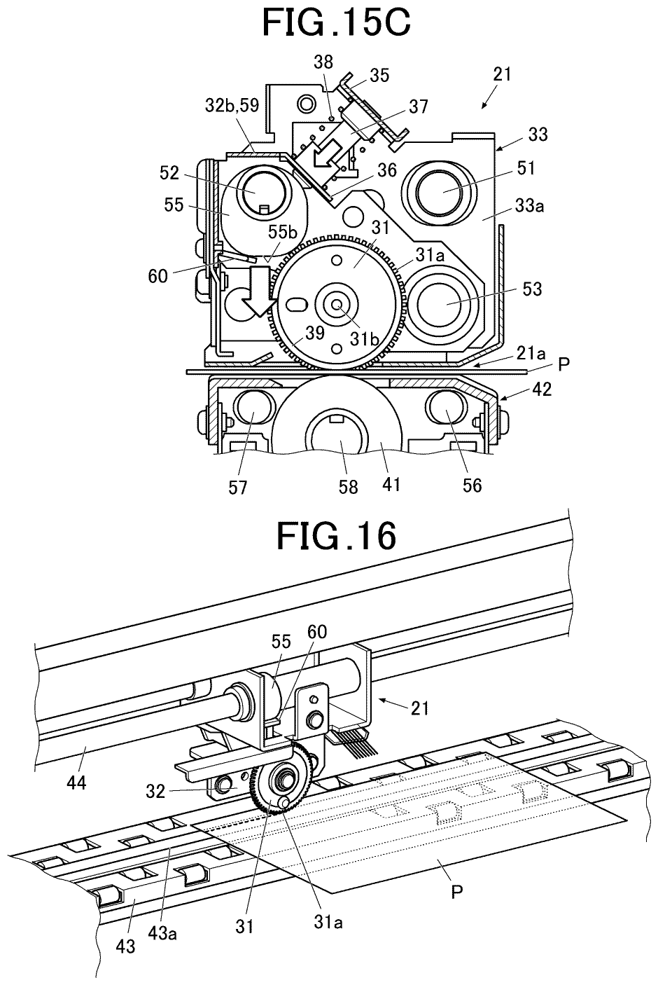

On the other hand, in a case where surface hardness of the conveyed sheet is higher than that of the plain sheet, when the cam 55 is rotated by the second drive motor 63 from the state illustrated in FIG. 15A in which the second section 55b of the cam 55 is in contact with the separating guide piece 59, the state may become the state illustrated in FIG. 15B. That is, even if the perforating blade 31a of the cutter 31 abuts on the surface of the sheet P by the biasing force of the compression spring 38, the perforating blade 31a may stay on the surface of the sheet P without penetrating through the sheet P. In such a case, the perforating blade 31a is in a state of being separated from the lower receiving base 41 via the sheet P (in a state of being separated from the lower receiving base by the amount of the sheet P). Along with this, the follow-up striking guide piece 60 provided on the cutter holding member 32 is also located at a relatively higher position than in the case where the perforating blade 31a penetrates the sheet. Therefore, the follow-up striking guide piece 60 is positioned within the moving route of the cam 55. Therefore, when the cam 55 rotates and the second section 55b is directed downward (rotates to a position facing the follow-up striking guide piece 60), the cam 55 comes into contact with the follow-up striking guide piece 60 and forcibly pushes the follow-up striking guide piece 60 downward.

As a result, as illustrated in FIG. 15C, the cutter holding member 32 rotates downward around the holding member rotation shaft 53, and thus the cutter 31 is pressed against the lower receiving base 41 and the perforating blade 31a penetrates the sheet P. Once the perforating blade 31a penetrates the sheet P, the succeeding perforating blade 31a is brought into contact with the sheet from its corner part with the movement of the sheet, so that a large biasing force is not required, and thereafter, the perforating blade 31a continues to penetrate the sheet only by the spring force of the compression spring 38. Even if the following perforating blade 31a does not penetrate the sheet P only by the spring force of the compression spring 38, the following perforating blade 31a continues to penetrate the sheet because the second section of the cam 55 is stopped at the position facing the follow-up striking guide piece 60.

Thereafter, when the formation of the perforation is stopped, the cam 55 is turned by the second drive motor 63, and the cam 55 is rotated such that the second section 55b of the cam 55 faces the separating guide piece 59. Thus, the cutter holding member 32 rotates upward around the holding member rotation shaft 53, so that the perforating blade 31a of the cutter 31 separates from the sheet P.

Therefore, according to the above-described configuration, it is possible to form the perforation at an intended place of the sheet P regardless of the type of the sheet (difference in surface hardness of the sheet).

Note that although the example applied to the FD perforation has been described above, a similar configuration can be adopted in a CD perforation. That is, as illustrated in FIG. 16, the perforation forming machine is configured to include the processing machine 21 which is provided with the cutter holding member 32 which holds the cutter 31 and the linear lower receiving base 43 which is provided so as to extend in the CD-direction (direction orthogonal to the conveyance direction of the sheet). The cutter holding member 32 is moved along a support shaft 44 stretched in the CD-direction to move the cutter 31 along the groove portion 43a formed on the upper surface of the lower receiving base 43.

In such a configuration, a biasing mechanism (not illustrated) that constantly biases the cutter 31 toward the lower receiving base 43 is provided. Furthermore, the cam 55 is provided so that the cutter 31 can be pressed against the lower receiving base 43 by the biasing force of the biasing mechanism and the cutter 31 is separated from the lower receiving base 43 against the biasing force of the biasing mechanism. Furthermore, in a state where the perforating blade 31a is separated from the lower receiving base 43 via the sheet P, the above-described follow-up striking guide piece 60 is arranged within the moving route of the cam 55. Thus, even when the perforating blade 31a is separated from the lower receiving base 43 through the sheet P, the perforating blade 31a is pressed down to a height where the cam 55 abuts on the follow-up striking guide piece 60 and the sheet P is penetrated, so that the perforation is surely formed on the sheet P.

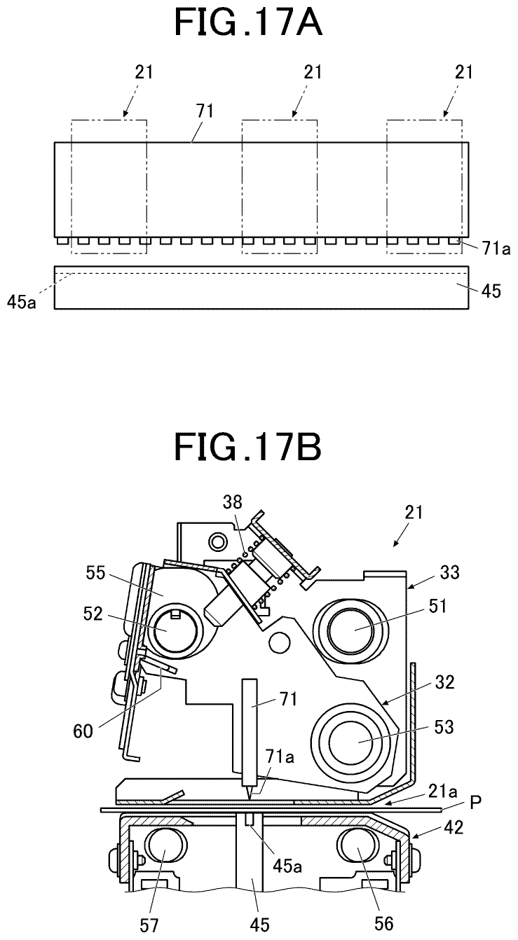

Furthermore, although the example in which the rotary cutter 31 is used has been described above, the present configuration is also useful in a case where the belly portions of a large number of perforating blades are made to simultaneously abut on the sheet to form the perforations in the sheet. For example, as illustrated in FIG. 17A and FIG. 17B, the cutter 71 is replaced with a guillotine-type cutter. In addition, a similar configuration can be adopted by replacing the lower receiving base 45 with a structure including a linear groove portion 45a to which the guillotine-type cutter 71 can be crimped (a large number of linearly arranged perforating blades 71a can be inserted).

Note that in the case of the guillotine-type cutter 71, since the belly portions of a large number of perforating blades 71a simultaneously abut against the surface of the sheet, it is likely to be difficult to cause the blade edge to penetrate the sheet with only the compression spring 38 used in the rotary type. Therefore, forcibly pressing the cutter holding member 32 downward by the cam 55 facilitates simultaneous penetration of a large number of perforating blades 71a through the sheet. At this time, unlike the rotary type, in the guillotine type, a large number of perforating blades are arranged linearly, and therefore, a plurality of processing machines 21 each including the cam 55 and the follow-up striking guide piece 60 may be provided at intervals along the direction in which the cutter 71 extends.

As described above, the perforation forming machine (perforation forming unit 20) according to the present embodiment is the perforation forming machine (perforation forming unit 20) including the processing machine 21 that enables the perforation to be formed by the sheet P being conveyed between the cutters 31, 71 including the perforating blades 31a, 71a, and the receiving base (lower receiving base 41, 43, 45) for receiving the cutters 31, 71. The perforation forming machine includes the biasing mechanism (compression spring 38) for constantly biasing the cutter 31, 71 toward the receiving base (lower receiving base 41, 43, 45), and the cam 55 for forming the state in which the cutters 31, 71 can be pressed against the receiving base (lower receiving base 41, 43, 45) by the biasing force of the biasing mechanism (compression spring 38) and the state in which the cutters 31, 71 are separated from the receiving base (lower receiving base 41, 43, 45) against the biasing force of the biasing mechanism (compression spring 38). In a state in which the perforating blades 31a and 71a are separated from the receiving base (lower receiving base 41, 43, 45) via the sheet P, the pressing portion (follow-up striking guide piece 60) is placed in the moving route of the cam 55 and the cutters 31, 71 are pressed toward the receiving base (lower receiving base 41, 43, 45). When the perforating blades 31a and 71a are separated from the receiving base (lower receiving base 41, 43, 45) through the sheet P, the cam 55 is brought into contact with the pressing portion (follow-up striking guide piece 60) and the perforating blades 31, 71 are displaced toward the receiving base (lower receiving base 41, 43, 45) thereby pressing down the perforating blades 31a and 71a to a height at which the perforating blades 31a and 71a are penetrated through the sheet P.

Therefore, even in a case where the perforating blades 31a and 71a of the cutter 31 and 71 do not penetrate the sheet P with high surface hardness only by the biasing force of the biasing mechanism (compression spring 38), the cam 55 is made to abut against the pressing portion (follow-up striking guide piece 60) to press down the perforating blades 31a and 71a to a height at which the perforating blades 31a and 71a penetrate the sheet P. Therefore, even when the surface hardness of the sheet is high, the sheet can be penetrated by the perforating blade 31a. That is, since it is not necessary to increase the biasing force of the biasing mechanism (compression spring 38) for pressing the cutters 31, 71 against the receiving bases (lower receiving bases 41, 43, 45), and it is not necessary to make the tooth tips of the perforating blades 31a, 71a more acute than necessary, it is possible to form perforations in the sheet regardless of the type of sheet while avoiding a decrease in durability of the perforating blades.

As a more specific aspect, the holding member (the cutter holding member 32) that holds the blades 31 and 71 and includes a pressing portion (the follow-up striking guide piece 60) may be provided, and the biasing mechanism may constantly bias the blades 31 and 71 toward the receiving bases (the lower receiving bases 41, 43, and 45) by biasing the holding member (the cutter holding member 32) with a biasing member (the compression spring 38).

Providing the biasing force via the holding member (the cutter holding member 32) that holds the cutters 31 and 71 facilitates creation of the structure that provides the biasing force.

In this case, the holding member (cutter holding member 32) can be turned around a fulcrum (holding member rotation shaft 53) arranged at a position apart from a part for holding the cutters 31, 71. Then, the pressing portion (the follow-up striking guide piece 60) may be arranged on the side opposite to the fulcrum (the holding member rotation shaft 53) with respect to the portion of the holding member (the cutter holding member 32) holding the cutters 31 and 71. In such a configuration, the cutters 31, 71 can be biased toward the receiving bases (lower receiving bases 41, 43, 45) by the principle of leverage. Therefore, it is not necessary to increase the shapes of the cam 55 and the pressing portion (the follow-up striking guide piece 60), and it is possible to avoid an increase in the size of the perforation forming machine.

Here, the cutters 31,71 may be a rotary type or a guillotine type. In particular, even in a case where the blade edge of the perforating blade comes into contact with the sheet from its belly part when forming the perforation, the cam 55 is made to come into contact with the follow-up striking guide piece 60 to press down the perforating blade 31a to a predetermined height, and thus the perforation can be easily and reliably formed regardless of the type of the cutter.

Here, when the cutter 31 is of a rotary type, the cutter 31 may be provided with an annular rubber roller 39 which is coaxial with and adjacent to the cutter 31. Thus, the cutter 31 can be rotated when the rubber roller 39 comes into contact with the sheet conveyed between the cutter 31 and the lower receiving base 41. With this structure, a power source for rotating the cutter 31 is unnecessary, and it is easy to reduce the size of the perforation forming machine (perforation forming unit 20).

Note that the formation direction of the perforations may be a direction (FD) parallel to the conveyance direction of the sheet or a direction (CD) orthogonal to the conveyance direction of the sheet.

Furthermore, as the sheet processing apparatus 200, the above-described perforation forming machine (perforation forming unit 20) may be detachably attached as one of the functional units. In such a configuration, the sheet processing apparatus 200 can be provided with a perforation forming function by user's selection, so that a dedicated device is not required. That is, by forming the perforation forming machine and the detachable functional units as one unit, it becomes easy to adopt the perforation forming machine in an in-line type sheet processing apparatus 200. Thus, it is easy to construct the image forming system 1 including the image forming apparatus 100 that forms the image on the sheet and the above-described sheet processing apparatus 200 that forms the perforation on the sheet on which the image is formed by the image forming apparatus 100.

With the above-described configuration, it is possible to provide the perforation forming machine, the sheet processing apparatus, and the image forming system that can form the perforations in the sheet regardless of the type of the sheet while avoiding a reduction in the durability of the perforating blade.

When the surface hardness of the sheet is high and the perforating blade does not penetrate the sheet only by the biasing force of the biasing mechanism applied to the cutter, the perforating blade is in a state of being separated from the receiving base via the sheet. In such a case, the perforating blade is forcibly pressed down by the cam abutting on the pressing portion, and penetrates the sheet. Therefore, it is possible to form a required perforation even on the sheet having high surface hardness.

### Supplemental

Although the embodiment and modification examples have been described for the perforation forming machine, the sheet processing apparatus, and the image forming system according to the present invention, the present invention is not limited to the above-described embodiment and modification examples. The present invention also includes embodiments obtained by applying various modification examples conceived by those skilled in the art to the above-described embodiments and modification examples, and embodiments realized by suitably combining the constituent elements and functions in the embodiments and modifications without departing from the spirit of the present invention. The scope of the present invention is to be interpreted by the appended claims.

The present invention is useful as a technique for forming the perforations in the sheet regardless of the type of sheet (the surface hardness of the sheet).

Although embodiments of the present invention have been described and shown in detail, the disclosed embodiments are made for purposes of illustration and example only and not limitation. The scope of the present invention should be interpreted by terms of the appended claims.

What is claimed is:

1. A perforation forming machine that includes a processing machine capable of forming a perforation on a sheet conveyed between a cutter including a perforating blade, and a receiving base that receives the cutter, the perforation forming machine comprising:
a biasing mechanism that constantly biases the cutter toward the receiving base; and
a cam configured to form a state in which the cutter can be pressed against the receiving base by a biasing force of the biasing mechanism and a state in which the cutter is separated from the receiving base against the biasing force of the biasing mechanism,
wherein a presser that is disposed within a moving route of the cam in a state in which the perforating blade is separated from the receiving base via the sheet and the presser is configured so as to be able to press the cutter toward the receiving base, and
wherein, in a case in which the perforating blade is separated from the receiving base via the sheet, the cam is made to abut against the presser to displace the cutter toward the receiving base, and the perforating blade is pressed down to a height at which the perforating blade penetrates the sheet.

2. The perforation forming machine according to claim 1,
further comprising a holding member that holds the cutter and that includes the presser,
wherein the biasing mechanism constantly biases the cutter toward the receiving base by biasing the holding member by a biasing member.

3. The perforation forming machine according to claim 2, wherein the holding member is rotatable about a fulcrum disposed at a position separated from a part holding the cutter, and the presser is disposed on a side opposite to the fulcrum with respect to the part of the holding member holding the cutter.

4. The perforation forming machine according to claim 2, wherein the cutter is a rotary type.

5. The perforation forming machine according to claim 4, wherein the cutter includes an annular rubber roller that is coaxial with and adjacent to the cutter, and the cutter is rotated by causing the sheet conveyed between the cutter and the receiving base to abut on the rubber roller.

6. The perforation forming machine according to claim 2, wherein the cutter is a guillotine type.

7. The perforation forming machine according to claim 2, wherein a formation direction of the perforation is a direction parallel to a conveyance direction of the sheet.

8. The perforation forming machine according to claim 2, wherein a formation direction of the perforation is a direction orthogonal to a conveyance direction of the sheet.

9. A sheet processing apparatus comprising:
the perforation forming machine according to claim 1 which is detachably attached to the sheet processing apparatus as one of functional units.

10. An image forming system comprising:
an image forming apparatus that forms an image on a sheet, and
the sheet processing apparatus according to claim 9 that forms the perforation on the sheet on which the image has been formed by the image forming apparatus.
